(19) United States
(12) Patent Application Publication
(10) Pub. No.: US 2008/0250893 A1
(43) Pub. Date: Oct. 16, 2008

(54) Two-piece coupling for a bicycle hydraulic disc brake

(75) Inventor: Szu-fang Tsai, Changhua (TW)

Correspondence Address: SAM CHEN, 7F-1, 293, ROOSEVELT ROAD, SEC 3, TAIPEI, TW

(73) Assignee: Tektro Technology Corporation

(21) Appl. No.: 11/734,279

(22) Filed: Apr. 12, 2007

(51) Int. Cl. F16C 1/10

(52) U.S. Cl. 74/502.4

(57) ABSTRACT

A coupling for a bicycle hydraulic disc brake including a brake cable having a hollow end section having a tapered, ridged inner surface is disclosed. The coupling includes a hollow cylinder including a lower member, a tapered, staged upper member, an intermediate annular flange, and a sealing ring put on the lower member to urge against the flange wherein the end section lockingly receives the upper member by engaging the ridges thereof with the stages of the upper member and engaging a bottom end thereof with the flange; and a sleeve rotatably put on a brake lever and including a cylindrical receptacle on the sleeve, the receptacle including inner annular grooves and a bottom tunnel communicating with the channel. The cylinder and the brake cable are secured to the sleeve by inserting the flange and the end section into the receptacle with the lower member disposed in the tunnel.

### BACKGROUND OF THE INVENTION

1. Field of Invention

The invention relates to bicycle hydraulic disc brake and more particularly to a two-piece coupling for a bicycle hydraulic disc brake with improved characteristics.

2. Description of Related Art

A first conventional coupling for a bicycle hydraulic disc brake is shown in FIG. 4. The coupling comprises a cylindrical collar 41 having an elongate projection 412 on a periphery, the projection 412 having a staged shank 413 adapted to secure to a brake cable (not numbered).

A second conventional coupling for a bicycle hydraulic disc brake is shown in FIG. 5. The coupling comprises a collar 11 having a hexagonal outer surface, the collar 11 including an elongate projection 112 on a periphery, the projection 112 having an externally threaded shank 113 adapted to secure to an internally threaded cylindrical member 12 which is again secured to a brake cable (not numbered).

However, the well known couplings suffer from a disadvantage. For example, the collar 41, the projection 412, and the shank 413 of the first conventional coupling and the collar 11, the projection 112, and the shank 113 of the second conventional coupling are formed by machining. This inevitably increases the manufacturing cost. Thus, the need for improvement still exists.

### SUMMARY OF THE INVENTION

It is therefore one object of the invention to provide a two-piece coupling for a bicycle hydraulic disc brake so as to reduce the manufacturing cost.

The above and other objects, features and advantages of the invention will become apparent from the following detailed description taken with the accompanying drawings.

### BRIEF DESCRIPTION OF THE DRAWINGS

FIG. 1 is an exploded view of a preferred embodiment of coupling for a bicycle hydraulic disc brake according to the invention;

FIG. 2 is a perspective view of the assembled coupling;

FIG. 3 is a a longitudinal sectional view of FIG. 2;

FIG. 4 is an exploded view of a first conventional coupling for a bicycle hydraulic disc brake; and

FIG. 5 is an exploded view of a second conventional coupling for a bicycle hydraulic disc brake.

### DETAILED DESCRIPTION OF THE INVENTION

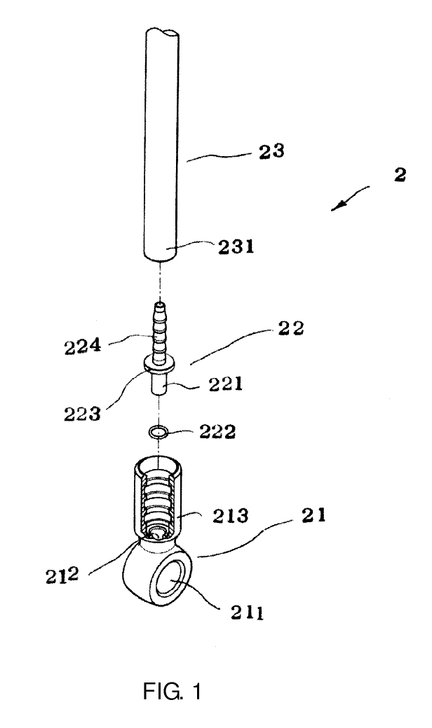

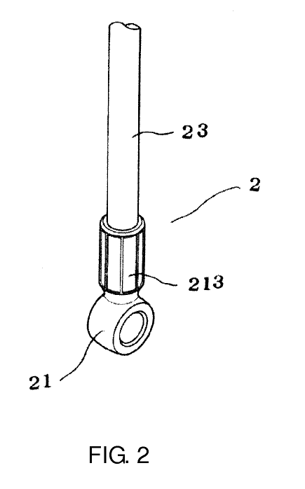

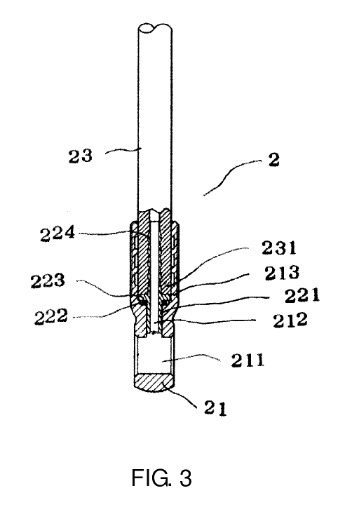

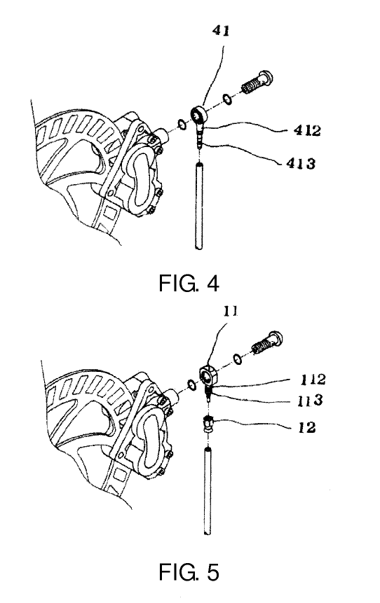

Referring to FIGS. 1 to 3, a coupling 2 for a bicycle hydraulic disc brake in accordance with a preferred embodiment of the invention comprises a sleeve 21 including an axial channel 211 for allowing a brake lever (not shown) to pass and allowing the sleeve 21 to rotate about the brake lever, and a cylindrical receptacle 213 projecting from a periphery of the sleeve 21, the receptacle 213 including a plurality of annular grooves (not numbered) on its inner surface and a bottom tunnel 212 being in communication with the channel 211.

The coupling 2 further comprises a hollow cylindrical post 22 including a lower section 221, a tapered, staged upper section 224, an annular flange 223 between the lower and upper sections 221 and 224, and an “O” ring 222.

A brake cable 23 has a hollow lower section 231 having a tapered inner surface with a plurality of annular ridges (not numbered) formed thereon.

An assembly of the invention will be described in detail below. The lower section 231 is dimensioned and shaped to lockingly receive the upper section 224 by engaging the ridges thereof with the stages of the upper section 224 with a bottom end of the lower section 231 engaged with the flange 223. The “O” ring 222 is tightly put on the lower section 221 to urge against the flange 223. The post 22 and the brake cable 23 together are secured to the sleeve 21 by inserting the lower section 231, the “O” ring 222, the flange 223, and the lower section 231 into the receptacle 213 until the “O” ring 222 rests upon a bottom shoulder portion of the receptacle 213 and the lower section 221 fits in the tunnel 212.

The invention has the advantage of providing two separate members formed by a single molding rather than machining a single member in a time consuming process as experienced in the prior art.

While the invention herein disclosed has been described by means of specific embodiments, numerous modifications and variations could be made thereto by those skilled in the art without departing from the scope and spirit of the invention set forth in the claims.

What is claimed is:

1. A coupling for a bicycle hydraulic disc brake including a brake lever and a brake cable having a hollow end section having a tapered inner surface and a plurality of annular ridges formed thereon, comprising:
a hollow cylindrical post including a lower member, a tapered, staged upper member, an intermediate annular flange, and a sealing ring securely put on the lower member to urge against the flange wherein the end section is adapted to lockingly receive the upper member by engaging the ridges thereof with the stages of the upper member and engaging a bottom end thereof with the flange; and
a sleeve rotatably put on the brake lever and including a cylindrical receptacle extending out of a periphery of the sleeve, the receptacle including a plurality of annular grooves on its inner surface and a bottom tunnel being in communication with the channel,
wherein the post and the brake cable together are secured to the sleeve by inserting the lower member, the sealing ring, the flange, and the end section into the receptacle with the sealing ring rested upon a bottom of the receptacle and the lower member disposed in the tunnel.
